(19) United States
(12) Patent Application Publication
(10) Pub. No.: US 2011/0141082 A1
(43) Pub. Date: Jun. 16, 2011

(54) ELECTROPHORETIC DISPLAY DEVICE, DRIVING METHOD OF ELECTROPHORETIC DISPLAY DEVICE, AND ELECTRONIC DEVICE

(75) Inventor: Katsunori YAMAZAKI, Matsumoto (JP)

(73) Assignee: SEIKO EPSON CORPORATION, TOKYO (JP)

(21) Appl. No.: 12/962,936

(22) Filed: Dec. 8, 2010

(30) Foreign Application Priority Data
Dec. 16, 2009 (JP) 2009-285025

(51) Int. Cl. G09G 3/34; G09G 5/00

(52) U.S. Cl. 345/209; 345/211; 345/107

(57) ABSTRACT

An electrophoretic display device includes an electrophoretic element having an electrophoretic layer interposed between a plurality of pixel electrodes and a common electrode, a storage capacitor and a selection transistor provided corresponding to each of the pixel electrodes for each pixel, a capacity line connected to an electrode of the storage capacitor, and a control unit controlling potentials at the pixel electrodes, the common electrode, and the capacity lines, wherein the control unit performs a potential writing operation of writing a predetermined potential in the storage capacitor and the pixel electrode during an image display period when images are displayed on a display region where the pixels are arranged, and a potential changing operation of changing a potential at the capacity line from a first potential to a second potential after the selection transistor is turned off.

### BACKGROUND

1. Technical Field

The present invention relates to an electrophoretic display device, a driving method of the electrophoretic display device, and an electronic device.

2. Related Art

There is known an electrophoretic display device of 1T1C type (DRAM type) where one transistor and one capacitor are formed in one pixel (for example, JP-A-2000-35775).

In JP-A-2000-35775, it was found that although the electrophoretic element is driven until all charges in a storage capacitor disappear, if an applied voltage is equal to or less than a certain predetermined threshold voltage, the electrophoretic element is not driven.

That is to say, if the storage capacitor is discharged and the voltage drops to equal to or less than the threshold voltage of the electrophoretic element, the electric energy thereafter is not used to drive the electrophoretic element but is consumed unnecessarily. As a result, recharging is needed several times, and, for this reason, power consumption (parasitic capacitors at data lines, and the like) for the driving increases. A time needed for drawing processes is lengthened, and thus the response is slow.

### SUMMARY

An advantage of some aspects of the invention is to provide an electrophoretic display device, a driving method of the electrophoretic display device, and an electronic device, capable of lengthening a time when an electrophoretic element can be driven by one-time charging of a storage capacitor, and of efficiently displaying images.

In accordance with an embodiment of the invention, there is provided an electrophoretic display device including an electrophoretic element having an electrophoretic layer interposed between a plurality of pixel electrodes and a common electrode; a storage capacitor and a selection transistor provided corresponding to each of the pixel electrodes for each pixel; a capacity line connected to an electrode of the storage capacitor; and a control unit controlling potentials at the pixel electrodes, the common electrode, and the capacity lines, wherein the control unit performs a potential writing operation of writing a predetermined potential in the storage capacitor and the pixel electrode during an image display period when images are displayed on a display region where the pixels are arranged; and a potential changing operation of changing a potential at the capacity line from a first potential to a second potential after the selection transistor is turned off.

According to an aspect of the invention, by performing a potential writing operation of writing a predetermined potential in the storage capacitor and the pixel electrode during an image display period, and a potential changing operation of changing a potential at the capacity line from a first potential to a second potential after the selection transistor is turned off, a potential at the pixel electrode is changed to increase an absolute value of a voltage between the pixel electrode and an opposite electrode. Thereby, it is possible to further lengthen the driving time of the electrophoretic element due to one-time charging of the storage capacitor as compared with a driving time in the related art, and to efficiently display images. In addition, it is possible to reduce the number of recharging times by suppressing the power consumption in the storage capacitor, and to increase the responsiveness of the electrophoretic element.

Also, it is preferable that the control unit performs the potential changing operation before a potential at the pixel electrode becomes lower than a threshold voltage of the electrophoretic element.

According to an aspect of the invention, by performing the voltage changing operation before a potential at the pixel electrode becomes lower than a threshold voltage of the electrophoretic element, it is possible to reduce useless power consumption in the storage capacitor which does not participate in the driving of the electrophoretic element.

Also, it is preferable that the control unit changes a potential at the capacity line to the first potential before or at the same time as the potential writing operation.

According to an aspect of the invention, by changing a potential at the capacity line to the first potential before the potential changing operation, it is possible to repeat the driving. Therefore, the power consumption in the storage capacitor can be reduced and a predetermined grayscale display can be implemented.

Also, it is preferable that the electrophoretic display device further includes a plurality of scanning lines and a plurality of data lines intersecting each other, wherein a gate of the selection transistor is connected to a first scanning line, a drain of the selection transistor is connected to one electrode of the storage capacitor, and the other electrode of the storage capacitor is connected to the second scanning line different from the first scanning line.

According to an aspect of the invention, the storage capacitor is connected to the second scanning line different from the first scanning line to which the selection transistor is connected, and thereby the second scanning line can function as a capacity line corresponding to the first scanning line. Thus, there is no need to form a capacity line independently, and thereby a device configuration is simplified and is also easily manufactured.

Also, it is preferable that the control unit includes a capacity line control circuit provided corresponding to each of the plurality of capacity lines, and first and second control lines connected to the capacity line control circuit, and the capacity line control circuit includes a first switch circuit inserted between the capacity line and the first control line, and a second switch circuit inserted between the capacity line and the second control line, and the first switch circuit is turned on when a selection potential turning on the selection transistor is applied to a first scanning line which a corresponding capacity line control circuit belongs to or the previous scanning line selected prior to the first scanning line, and the second switch circuit is turned on when the selection potential is applied to a second scanning line different from the first scanning line.

According to an aspect of the invention, it is possible to implement the electrophoretic display device which can change a potential at the capacity line in synchronization with the selection operation of the scanning line.

Also, it is preferable that the first switch circuit of the capacity line control circuit is constituted by a first transistor, the second switch circuit thereof is constituted by a second transistor, and the capacity line control circuit includes a third transistor and a fourth transistor, wherein drains of the first and second transistors are connected to the capacity line, a source of the first transistor is connected to the first control line, and a source of the second transistor is connected to the second control line, wherein gates of the first and third transistors are connected to a first scanning line which a corresponding capacity line control circuit belongs to or the scanning line different from the first scanning line, and a gate of the second transistor is connected to drains of the third and fourth transistors, wherein a source of the third transistor is connected to a third control line, wherein a gate of the fourth transistor is connected to the second scanning line, and wherein a source of the fourth transistor is connected to a fourth control line.

According to an aspect of the invention, due to the simple circuit configuration which can be integrally formed with a display part, it is possible to implement the electrophoretic display device which can change a potential at the capacity line in synchronization with the selection operation of the scanning line.

In addition, it is preferable that the first switch circuit of the capacity line control circuit is constituted by a first transistor, the second switch circuit thereof is constituted by a second transistor, and the capacity line control circuit includes a third transistor, a fourth transistor, a fifth transistor, and a sixth transistor, wherein drains of the first and second transistors are connected to the capacity line, a source of the first transistor is connected to the first control line, and a source of the second transistor is connected to the second control line, wherein a gate of the first transistor is connected to drains of the fifth and sixth transistors, a gate of the second transistor is connected to drains of the third and fourth transistors, and gates of the third and fifth transistors are connected to the first scanning line or the scanning different from the first scanning line, wherein gates of the fourth and sixth transistors are connected to the second scanning line, wherein sources of the third and sixth transistors are connected to a third control line, and wherein sources of the fourth and fifth transistors are connected to a fourth control line.

According to an aspect of the invention, due to the simple circuit configuration which can be integrally formed with a display part, it is possible to implement the electrophoretic display device which can change a potential at the capacity line at an arbitrary timing in synchronization with the selection operation of the scanning line.

It is preferable that the storage capacitor is provided in plurality for each pixel.

According to an aspect of the invention, the storage capacitor is provided in plurality for each pixel, and thereby it is possible to maintain a driving state of the electrophoretic element for a longer time.

In accordance with an embodiment of the invention, there is provided a driving method of an electrophoretic display device including an electrophoretic element having an electrophoretic layer interposed between a plurality of pixel electrodes and a common electrode; a storage capacitor and a selection transistor provided corresponding to each of the pixel electrodes for each pixel; a capacity line connected to an electrode of the storage capacitor; and a control unit controlling potentials at the pixel electrodes, the common electrode, and the capacity lines, the driving method including performing a potential writing operation of writing a predetermined potential in the storage capacitor and the pixel electrode during an image display period when images are displayed on a display region where the pixels are arranged; and performing a potential changing operation of changing a potential at the capacity line from a first potential to a second potential after the selection transistor is turned off.

According to an aspect of the invention, by performing a potential writing operation of writing a predetermined potential in the storage capacitor and the pixel electrode during an image display period, and a potential changing operation of changing a potential at the capacity line from a first potential to a second potential after the selection transistor is turned off, a potential at the pixel electrode is changed to increase an absolute value of a voltage between the pixel electrode and an opposite electrode. Thereby, it is possible to further lengthen the driving time of the electrophoretic element due to one-time charging of the storage capacitor as compared with a driving time in the related art and to efficiently display images. In addition, it is possible to reduce the number of recharging times by suppressing the power consumption in the storage capacitor, and to increase the responsiveness of the electrophoretic element.

Also, it is preferable that the potential changing operation is performed before a potential at the pixel electrode becomes lower than a threshold voltage of the electrophoretic element.

According to an aspect of the invention, a voltage applied to the electrophoretic element is increased by performing the potential changing operation before a potential at the pixel electrode becomes lower than a threshold voltage of the electrophoretic element, and thus it is possible to reduce useless power consumption in the storage capacitor which does not participate in the driving of the electrophoretic element.

Also, it is preferable that a potential at the capacity line is changed to the first potential before or at the same time as the potential writing operation.

According to an aspect of the invention, when charging is repeated, a potential at the capacity line is changed to the first potential before the potential changing operation, and the potential at the capacity line is changed to the second potential after charging, it is possible to heighten an absolute value of the voltage between the pixel electrode and an opposite electrode.

Also, it is preferable that a potential with a polarity opposite to a polarity of a voltage obtained by subtracting the first potential from the second potential is written in the pixel electrode of the corresponding pixel when a display using the pixel is intended to be maintained.

According to an aspect of the invention, a potential with a polarity opposite to a polarity of a voltage obtained by subtracting the first potential from the second potential is written in the pixel electrode of a pixel where a display is not changed, and thereby a pixel voltage when a potential at the capacity line is changed is equal to or less than the threshold voltage, and thus the display is prevented from being changed.

Also, it is preferable that when a state of the pixel is intended to be changed to a desired display state, either the first potential or the second potential is changed depending on the changed state.

According to an aspect of the invention, for example, a changed polarity when a pixel displays white is made reverse to a changed polarity at the time of changing a polarity of the capacity line after writing when the pixel displays black, and thus it is possible to considerably decrease the power consumption in the storage capacitor.

An electronic device according to an aspect of the invention includes the above-described electrophoretic display devices.

According to an aspect of the invention, it is possible to provide an electronic device having a display unit capable of implementing a high quality display.

### BRIEF DESCRIPTION OF THE DRAWINGS

The invention will be described with reference to the accompanying drawings, wherein like numbers reference like elements.

FIG. 1 is a schematic configuration diagram of an electrophoretic display device according to a first embodiment.

FIG. 2 is a circuit configuration diagram of a pixel.

FIG. 3A is a partially sectional view of the electrophoretic display device in a display region.

FIG. 3B is a schematic sectional view of a microcapsule.

FIG. 4A is a plan view of an element substrate regarding one pixel.

FIG. 4B is a sectional view taken along the line IVB-IVB in FIG. 4A.

FIGS. 5A and 5B are explanatory diagrams of the electrophoretic element.

FIG. 6 is a timing chart in an image forming display period according to the first embodiment.

FIG. 7 is a timing chart in a case where display is not changed.

FIG. 8 is a timing chart in a case where display is reversed.

FIG. 9 is a circuit configuration diagram of a pixel of an electrophoretic element according to a second embodiment.

FIG. 10 is a timing chart in an image forming display period according to the second embodiment.

FIG. 11 is a schematic configuration diagram of a display region and a non-display region according to a third embodiment.

FIG. 12 is a schematic configuration diagram of a display region and a non-display region according to a fourth embodiment.

FIG. 13 is an example of an electronic device.

FIG. 14 is an example of an electronic device.

FIG. 15 is an example of an electronic device.

### DESCRIPTION OF EXEMPLARY EMBODIMENTS

Hereinafter, embodiments of an electrophoretic display device and electronic devices related to the invention will be described with reference to the accompanying drawings.

Also, the invention is not limited to the following embodiments but may be arbitrarily modified within a scope of the technical conceptions of the invention. In addition, in the appended drawings, for better understanding of each constituent element, the scaling or the dimensions may be different in the actual individual structures.

### First Embodiment

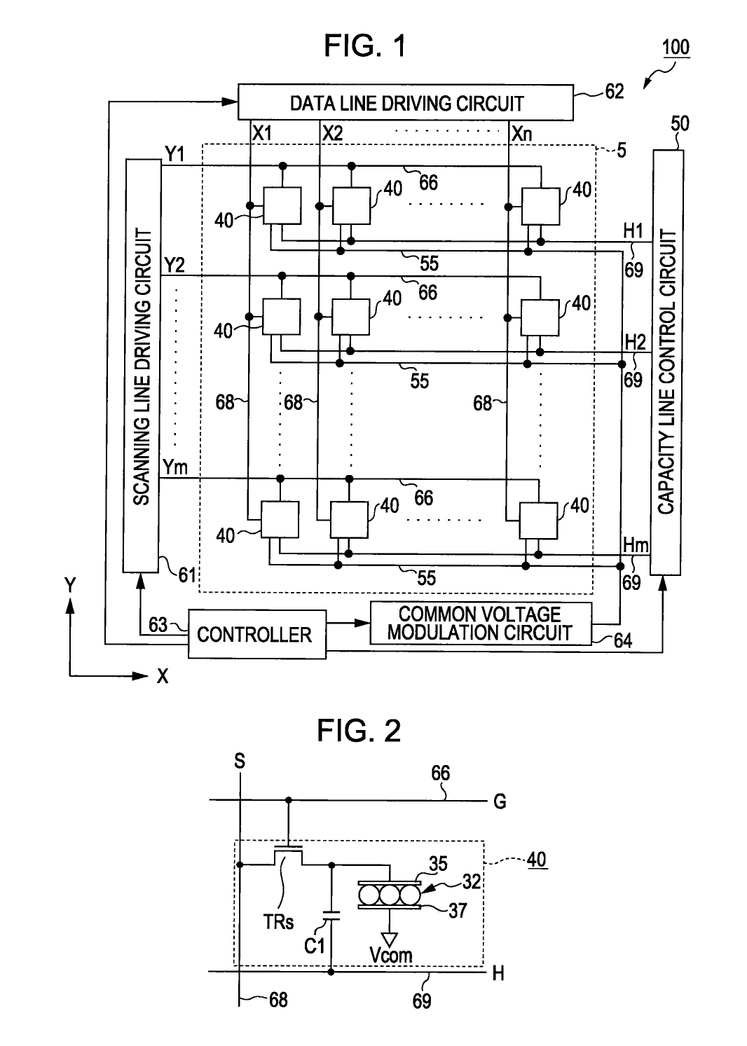

FIG. 1 is a schematic configuration diagram of an electrophoretic display device 100 according to an embodiment of the invention.

The electrophoretic display device 100 is provided with a display region 5 where a plurality of pixels 40 is arranged in a matrix. In the vicinity of the display region 5, a scanning line driving circuit 61, a data line driving circuit 62, a controller (control unit) 63, a common voltage modulation circuit 64, and a capacity line control circuit 50 are disposed. The scanning line driving circuit 61, the data line driving circuit 62, the common voltage modulation circuit 64, and the capacity line control circuit 50 are respectively connected to the controller 63. The controller 63 collectively controls the above-described elements based on image data or synchronization signals supplied from a high rank device.

A plurality of scanning lines 66 extending from the scanning line driving circuit 61, a plurality of data lines 68 extending from the data line driving circuit 62 are provided in the display region 5, and the pixels 40 are disposed at the intersections thereof. Also, a plurality of capacity lines 69 extending from the capacity line control circuit 50 are disposed in parallel to the scanning lines 66, each of which is connected to the pixels 40. A plurality of common electrode lines 55 extending from the common voltage modulation circuit 64 is also connected to each pixel 40. Here, the common electrode lines 55 corresponding to electrical connections between common electrodes 37 (see FIG. 2) common to the plurality of pixels 40 of the display region 5 and the common voltage modulation circuit 64 are indicated by lines for convenience.

The scanning line driving circuit 61 is connected to each pixel 40 via m scanning lines 66 (Y1, Y2, . . . , and Ym), and under the control of the controller 63, sequentially selects the first to the m-th scanning lines 66 and supplies a selection signal defining turning-on timing of a selection transistor TRs (see FIG. 2) provided in each pixel 40 via the selected scanning lines 66.

The data line driving circuit 62 is connected to each pixel 40 via n data lines 68 (X1, X2, . . . , and Xn), and, under the control of the controller 63, supplies, to each of the pixels 40, an image signal defining pixel data corresponding to each pixel 40.

The capacity line control circuit 50 generates various kinds of signals to be supplied to each of the capacity lines 69 (H1, H2, . . . , and Hm) under the control of the controller 63.

The common voltage modulation circuit 64 generates various kinds of signals to be supplied to each of the common electrode lines 55 and performs electrical connection and disconnection (high impedance (Hi-Z)) for the common electrode lines, under the control of the controller 63.

Also, in this embodiment, a written polarity is referred to as a positive polarity when a potential at a pixel electrode 35 is higher than a potential Vcom at the common electrode 37 and referred to as a negative polarity when lower, in the state where a voltage corresponding to a grayscale is maintained in an electrophoretic element 32. The voltage Vcom used as a reference is 0 V, which will be described later.

FIG. 2 is a circuit configuration diagram of the pixel 40.

The pixel 40 includes a selection transistor TRs, a storage capacitor C1, the pixel electrode 35, an electrophoretic element 32, and the common electrode 37. Also, the scanning line 66, the data line 68, and the capacity line 69 are connected to the pixel 40. The selection transistor TRs is an N-MOS (negative metal oxide semiconductor) transistor.

The selection transistor TRs may be replaced with other kinds of switching elements which have the same function. For example, instead of the N-MOS transistor, a P-MOS transistor may be used, or an inverter or a transmission gate may be used.

A gate of the selection transistor TRs is connected to the scanning line 66, a source thereof is connected to the data line 68, and a drain thereof is connected to one electrode of the storage capacitor C1 and the pixel electrode 35. The other electrode of the storage capacitor C1 is connected to the capacity line 69. The electrophoretic element 32 is interposed between the pixel electrode 35 and the common electrode 37.

The storage capacitor C1 is formed on a later-described element substrate 30 and formed by a pair of electrodes opposite to each other with a dielectric film interposed therebetween. The one electrode of the storage capacitor C1 is connected to the selection transistor TRs, and the other electrode thereof is connected to the capacity line 69. The storage capacitor C1 is charged with an image signal voltage which is written via the selection transistor TRs.

The electrophoretic element 32 is constituted by a plurality of microcapsules each including electrophoretic particles.

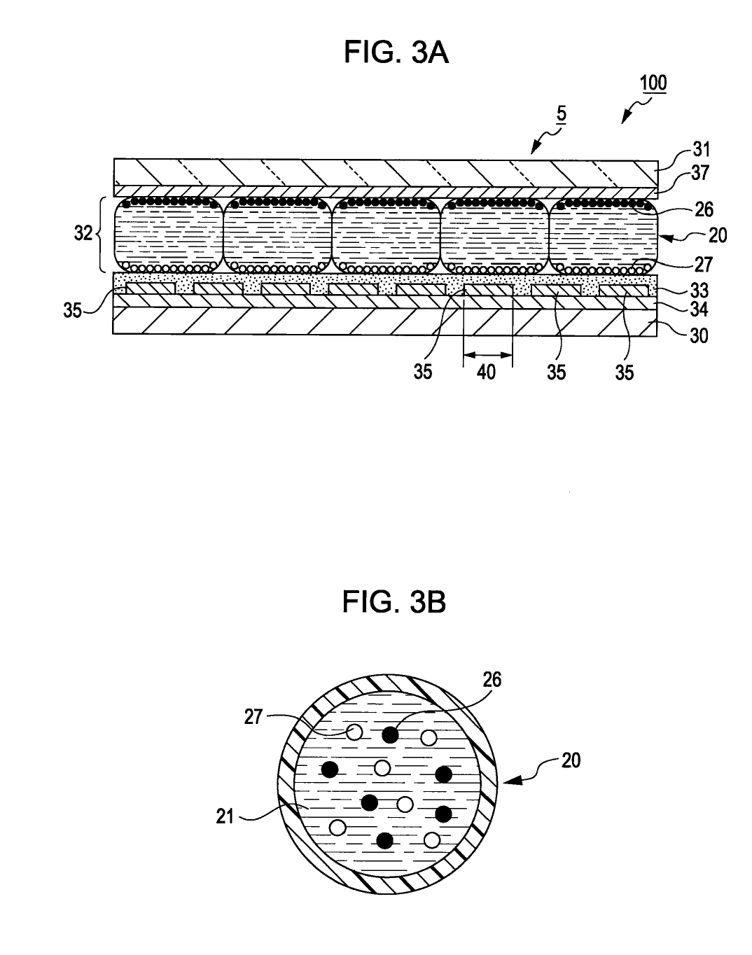

FIG. 3A is a partially sectional view of the electrophoretic display device 100 in the display region 5. The electrophoretic display device 100 has a configuration where the electrophoretic element 32 formed by arranging a plurality of microcapsules 20 is interposed between the element substrate 30 and an opposite substrate 31.

In the display region 5, in the electrophoretic element 32 side of the element substrate 30, a circuit layer 34 provided with the scanning lines 66, the data lines 68, the selection transistors TRs shown in FIG. 1 or FIG. 2 is disposed, and a plurality of pixel electrodes 35 is disposed on the circuit layer 34.

The element substrate 30 is made of glass or plastic and may not be transparent since it is positioned at a side opposite to an image display surface. The pixel electrode 35 is an electrode which supplies a voltages to the electrophoretic element 32 which is formed by laminating a nickel plate and a gold plate on a Cu (copper) foil or which is made of Al (aluminum), ITO (indium tin oxide), or the like.

In the electrophoretic element 32 side of the opposite substrate 31, the planar common electrode 37 facing a plurality of pixel electrodes 35 is formed, and the electrophoretic element 32 is provided on the common electrode 37.

The opposite substrate 31 is made of glass or plastic and is a transparent substrate since it is positioned at the image display side. The common electrode 37 is an electrode supplying a voltage to the electrophoretic element 32 along with the pixel electrode 35, and is a transparent electrode made of MgAg (magnesium silver), ITO (indium tin oxide), IZO (indium zinc oxide), or the like.

The electrophoretic element 32 and the pixel electrodes 35 are adhered to each other via an adhesive layer 33 and thereby the element substrate 30 and the opposite substrate 31 are joined together.

The electrophoretic element 32 is formed in the opposite substrate 31 side in advance, and is generally handled as a electrophoretic sheet including the adhesive layer 33. In a manufacturing process, the electrophoretic sheet is handled in a state of attaching a protective release sheet to the surface of the adhesive layer 33. The electrophoretic sheet from which the release sheet is detached is attached to the element substrate 30 (on which the pixel electrodes 35 and various kinds of circuits are formed) which is independently manufactured, thereby forming the display region 5. Accordingly, the adhesive layer 33 exists only in the pixel electrodes 35 side.

FIG. 3B is a schematic sectional view of the microcapsule 20. The microcapsule 20 has a particle size of, for example, about 50 μm, and is a round body which encapsulates a dispersion medium 21, a plurality of white particles (electrophoretic particles) 27, and a plurality of black particles (electrophoretic particles) 26 therein. The microcapsules 20 are interposed between the common electrode 37 and the pixel electrodes 35, as shown in FIG. 3A, and one or plural microcapsules 20 are disposed in one pixel 40.

The shell region (wall film) of the microcapsule 20 is formed using translucent polymer resin or the like, for example, acryl resin such as methyl polymethacrylate and ethyl polymethacrylate, urea resin, and Arabia gum.

The dispersion medium 21 is liquid where the white particles 27 and the black particles 26 are dispersed in the microcapsule 20. The dispersion medium 21 may include water, an alcoholic solvent (methanol, ethanol, isopropanol, butanol, octanol and methyl cellosolve, and the like), esters (ethyl acetate and butyl acetate), ketones (acetone, ethyl methyl ketone, methyl isobutyl ketone, and the like), an aliphatic hydrocarbon (pentane, hexane, octane, and the like), alicyclic hydrocarbon (cyclohexane, methyl cyclohexane, and the like), an aromatic hydrocarbon (benzene, a toluene, and benzenes with a long-chain alkyl group (xylene, hexyl benzene, hebuthyl benzene, octyl benzene, nonyl benzene, decyl benzene, undecyl benzene, dodecyl benzen, tridecyl benzene, tetradecyl benzene, and the like)), a halogenate hydrocarbon (methylene chloride, chloroform, carbon tetrachloride and 1,2-dichloroethane, and the like), and carboxylic acid salt, and the like, and it may be other oils. It is possible to employ these materials independently or in a mixture, and further a surfactant may be combined therewith.

The white particle 27 is a particle (polymer or colloid) made of a white pigment such as, for example, titanium dioxide, zinc oxide, and antimony trioxide, and, for example, may be used in a state of being charged with a negative polarity. The black particle 26 is a particle (polymer or colloid) made of a black pigment such as, for example, aniline black and carbon black, and, for example, may be used in a state of being charged with a positive polarity.

To the pigments, if necessary, there may be an addition of electrolyte, surfactant, metallic soap, resin, rubber, oil, varnish, charge control agent including particles such as compounds, dispersion agent such as titanium-based coupling agent, aluminum-based coupling agent, and silane-based coupling agent, lubricant agent, stabilizing agent, or the like.

Also, instead of the black particle 26 and the white particle 27, for example, pigments such as red color, green color, and blue color may be used. According to this configuration, red color, green color, blue color, and the like may be displayed on the display region 5.

In addition, one-colored particles may be dispersed in a colored dispersion medium 21.

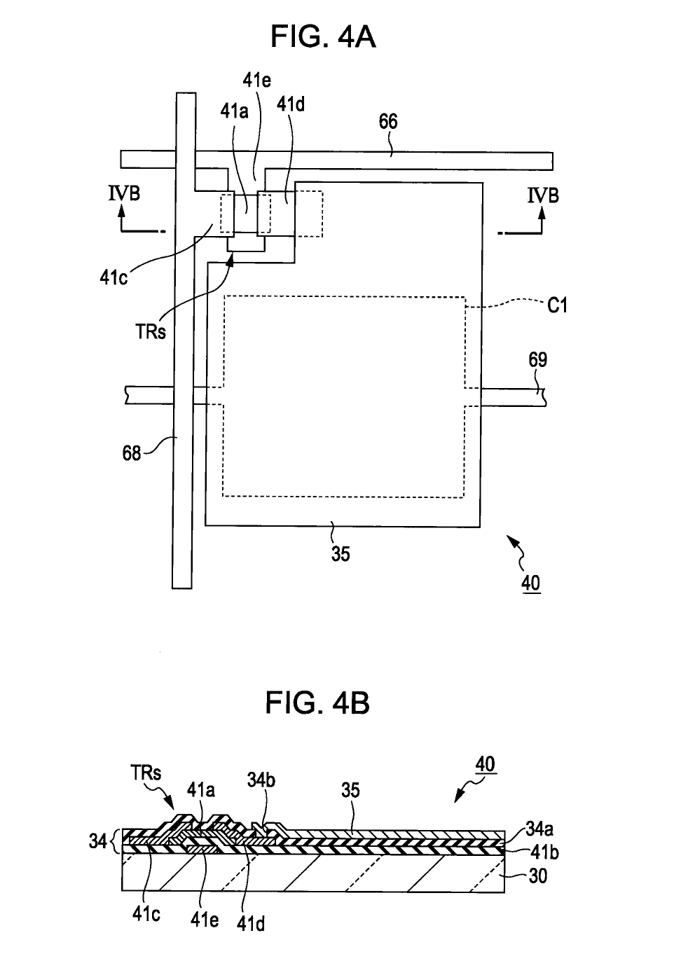

Here, FIG. 4A is a plan view of the element substrate 30 corresponding to one pixel 40, and FIG. 4B is a sectional view taken along the line IVB-IVB in FIG. 4A.

As shown in FIG. 4A, the selection transistor TRs includes a substantially rectangular semiconductor layer 41a when seen from the top, a source electrode 41c extending from the data line 68, a drain electrode 41d connecting the semiconductor layer 41a to the pixel electrode 35, and a gate electrode 41e extending from the scanning line 66. The storage capacitor C1 is formed at a region where the pixel electrode 35 overlaps with the capacity line 69.

In the sectional structure shown in FIG. 4B, the gate electrode 41e (scanning line 66) made of Al or Al alloy is formed on the element substrate 30, and a gate insulating layer 41b made of silicon oxide or silicon nitride is formed to cover the gate electrode 41e. The semiconductor layer 41a made of amorphous silicon or poly silicon is formed at a region opposite to the gate electrode 41e with the gate insulating layer 41b interposed therebetween. The source electrode 41c and the drain electrode 41d made of Al or Al alloy are formed on a portion of the semiconductor layer 41a. An interlayered insulating layer 34a made of silicon oxide or silicon nitride is formed to cover the source electrode 41c (data line 68), the drain electrode 41d, the semiconductor layer 41a, and the gate insulating layer 41b. The pixel electrode 35 is formed on the interlayered insulating layer 34a. The pixel electrode 35 is connected to the drain electrode 41d via a contact hole 34b penetrating the interlayered insulating layer 34a and reaching the drain electrode 41d.

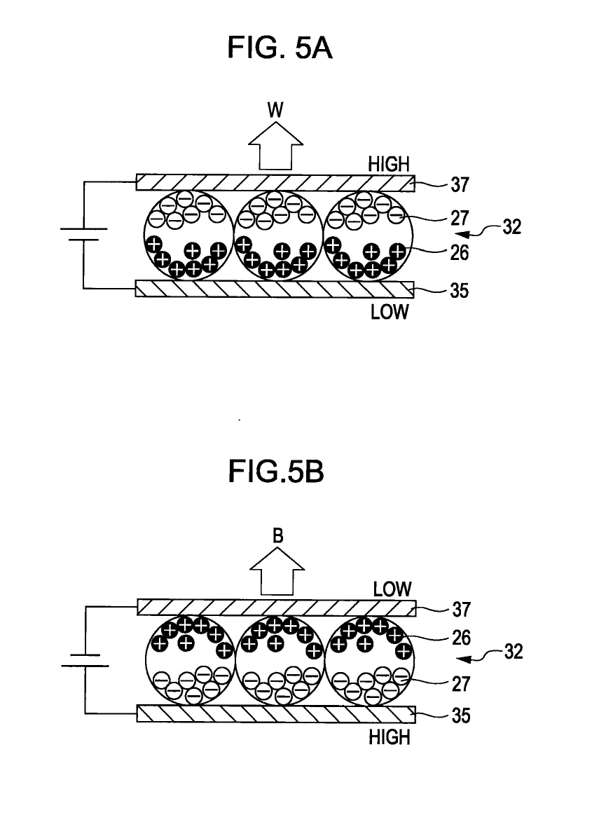

FIGS. 5A and 5B are explanatory diagrams illustrating an operation of the electrophoretic element. FIG. 5A shows a case where the pixel 40 displays white and FIG. 5B shows a case where the pixel 40 displays black.

In the case of the white display shown in FIG. 5A, the common electrode 37 is maintained to be a relatively high potential, and the pixel electrode 35 is maintained to be a relatively low potential. Thus, the white particles 27 charged with a negative polarity are attracted close to the common electrode 37 and the black particles 26 with a positive polarity are attracted close to the pixel electrode 35. As a result, when the pixels are seen from the common electrode 37 side which is a display surface side, the white color W is recognized.

In the case of the black display shown in FIG. 5B, the common electrode 37 is maintained to be a relatively low potential, and the pixel electrode 35 is maintained to be a relatively high potential. Thus, the black particles 26 charged with a positive polarity are attracted close to the common electrode 37 and the white particles 27 charged with a negative polarity are attracted close to the pixel electrode 35. As a result, when the pixels are seen from the common electrode 37 side, the black color B is recognized.

### Driving Method

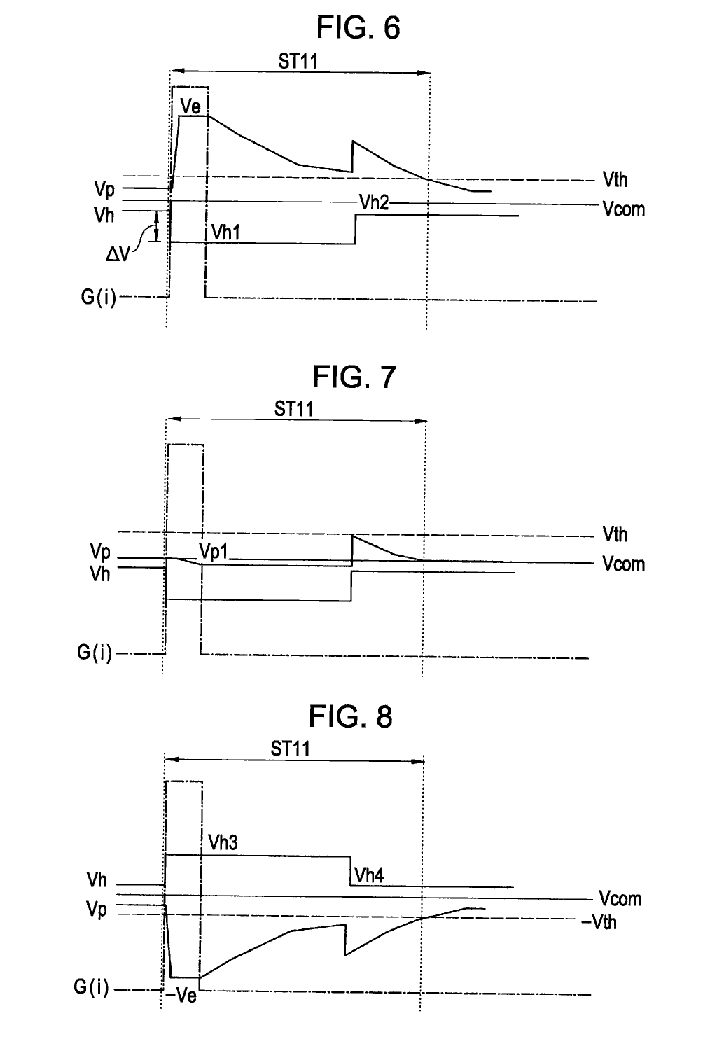

Next, a driving method of the electrophoretic display device in this embodiment will be described with reference to FIG. 6. FIG. 6 is a timing chart of a driving method of the electrophoretic display device 100. In FIG. 6, during an image forming display period ST11 when black display images are displayed on the display region 5 which entirely displays white in the electrophoretic display device 100, a potential at the common electrode 37 (a potential Vcom) regarding one pixel 40 is used as a reference. A voltage waveform G(i) for the scanning line 66, a voltage waveform Vh for the capacity line 69, and a voltage waveform Vp for the pixel electrode are shown.

Since the potential at the common electrode 37 (potential Vcom) is used as a reference (0 V), a voltage at the pixel electrode is a voltage applied to the electrophoretic element. Also, a voltage waveform for the common electrode 37 is not shown.

During the image forming display period ST11, a potential writing step of writing a predetermined potential in the storage capacitor C1 and the pixel electrode 35, and a potential changing step of changing a potential at the capacity lines 69 are performed.

In the potential writing step, first, the scanning line driving circuit 61 sequentially selects the scanning lines 66 of the respective rows. A selection voltage (for example, 20 V) for turning on the selection transistor TRs is input to the selected scanning lines 66 as shown in FIG. 6. A first hold voltage (Vh1) is input to the capacity lines 69 in synchronization with the selection operation of the scanning lines 66. In this embodiment, although the voltage Vh at the capacity line 69 is changed to the first hold voltage Vh1 at the same time as the selection operation of the scanning line 66, the voltage Vh at the capacity line 69 may be changed in advance before a predetermined scanning line 66 is selected.

If the selection transistor TRs connected to the selected scanning line 66 (scanning line 66 of the i-th row, which is, hereinafter, abbreviated to the i-th scanning line 66) is turned on, an image data voltage Ve (for example, 15 V) is supplied to each pixel 40 from the data line 68 and thus is charged in the storage capacitor C1. The voltage Vp of the pixel electrode 35 can be set to the voltage Ve corresponding to a display grayscale.

Thereafter, when the scanning line 66 is made not to be selected, a non-selection voltage (for example, −20 V) is applied to the scanning line 66, in turn the selection transistor TRs is turned off, this enables the pixel electrode 35 to enter a high impedance state, and the voltage at the pixel electrode 35 is maintained by energy stored in the storage capacitor C1. Therefore, the electrophoretic element 32 is driven based on the voltage between the pixel electrode 35 and the common electrode 37 and thus it is possible to implement a display corresponding to a desired grayscale.

Since the electric charges in the storage capacitor C1 are supplied to the electrophoretic element 32 to move charged particles in the electrophoretic element 32, and the change in the display state is made, the voltage Vp at the pixel electrode 35 connected to the one electrode of the storage capacitor C1 is gradually reduced from the voltage Ve.

Thus, in the potential changing step, before the voltage Vp of the pixel electrode 35 becomes the threshold voltage Vth or less, the voltage Vh at the capacity lines 69 is increased. Specifically, the capacity line control circuit 50 changes the voltage Vh at the capacity lines 69 from the first hold voltage Vh1 (the first potential) to a second hold voltage Vh2 (a second potential) higher than the first hold voltage Vh1. For example, as the second hold voltage Vh2, a voltage higher than the first hold voltage Vh1 by 7.5 V is applied. Also, since a difference between the first hold voltage Vh1 and the second hold voltage Vh2 is needed, values of the voltages do not matter. Therefore, the voltage (the voltage Vp at the pixel electrode 35) at the pixel electrode 35 side of the storage capacitor C1 is increased, the voltage Vp at the pixel electrode 35 becomes greater again, and thus it is possible to drive the electrophoretic element 32 continuously.

The timing for varying the voltage Vh at the capacity line 69 follows the electro-optical characteristics of the electrophoretic element 32; however, the variation in the voltage Vh may be performed immediately after the next row is selected until the voltage Vp of the pixel electrode 35 becomes a voltage equal to or less than the threshold voltage Vth.

FIG. 7 is a timing chart in a pixel where the display is not changed.

As for a pixel where the display is not changed (a pixel where the white display is maintained), a potential with a polarity opposite to a polarity of a voltage obtained by subtracting the first hold voltage Vhf from the second hold voltage Vh2 is written in the pixel electrode 35 of the pixel.

In other words, as shown in FIG. 7, after the selection transistor TRs is turned on through the selected scanning line 66, a predetermined negative potential is supplied to the data line 68 connected to the pixel 40 where the display is not changed. In this embodiment, as for the writing of an image data signal in a specific pixel 40, a negative voltage Vp1 (for example, −2 V) is written in the pixel electrode 35.

If the voltage Vh at the capacity lines 69 is changed at the above-described timing, the voltage Vp at the pixel electrode 35 of the non-selected pixel is increased in synchronization therewith. At this time, since the pixel electrode 35 of the non-selected pixel has been applied with the negative voltage Vp1, although the voltage Vp at the pixel electrode 35 increases, it does not reach a high voltage, and thus it is prevented to become the threshold voltage Vth or more. Thus, the change in the display is prevented to thereby maintain the white display.

Here, by setting the voltage Vp supplied to the pixel electrode 35 of the pixel where the display is not changed depending on the amount of a voltage changed at the capacity line 69, since the voltage Vp at the pixel electrode 35 is equal to or less than the threshold voltage Vth when the voltage Vh at the capacity line 69 becomes the second hold voltage Vh2, the white pixel is not changed to the black pixel.

As described above, when the pixel 40 displays black, a predetermined voltage is written in the storage capacitor C1 and the pixel electrode 35, and simultaneously the voltage Vh at the capacity line 69 becomes the first hold voltage Vh1 and the selection transistor TRs is turned off, and then the voltage Vh at the capacity line 69 is changed from the first hold voltage Vh1 to the second hold voltage Vh2. Accordingly, the voltage Vp at the pixel electrode 35 which is gradually reduced due to the discharge in the storage capacitor C1 increases.

In this way, the voltage Vh at the storage capacitor C1 increases before the voltage Vp at the pixel electrode 35 is reduced to a voltage lower than the threshold voltage Vth of the electrophoretic element 32, and thereby the voltage Vp at the pixel electrode 35 becomes greater, and it is possible to suppress the voltage Vp at the pixel electrode 35 from being reduced to a voltage lower than the threshold voltage Vth of the electrophoretic element 32. In other words, by increasing the voltage Vh at the storage capacitor C1 to increase a voltage applied to the electrophoretic element 32, it is possible to prevent the energy in the storage capacitor C1 from being consumed and to drive the electrophoretic element 32 continuously.

The driving method in this embodiment as described above can further lengthen the driving time of the electrophoretic element 32 as compared with the driving time in the related art. If the driving time during one scanning period is lengthened, the number of repeated writings can be reduced. As a result, the number of recharging times can be reduced, and the display is enabled even when the number of writings is reduced. Thus, power consumed by the parasitic capacitors in the data lines 68 is considerably decreased. It is possible to further lengthen the driving time of the electrophoretic element 32 due to the one-time charging of the storage capacitor C1, and to efficiently perform the image display operation. That is to say, it is possible to notably reduce useless power consumption in the storage capacitor C1 which does not participate in the driving of the electrophoretic element 32, and to heighten the responsiveness of the electrophoretic element 32.

Also, in this embodiment, a predetermined potential is written in the storage capacitor C1 and the pixel electrode 35 and the voltage Vh at the capacity line 69 is the first hold voltage Vh1. This is because the first hold voltage Vh1 is changed to the second hold voltage Vh2 again after recharging and the above-described effects are achieved again, and because if the recharging is performed in the state of applying the second hold voltage Vh2, in order to achieve the above-described effects, a voltage higher than the second hold voltage Vh2 is needed, and when the recharging is repeated, a higher and higher hold voltage is needed.

In addition, the timing when the voltage Vh at the capacity line 69 becomes the first hold voltage Vh1 may not be necessarily the same time as the charging, but may be prior to the charging period.

As for the pixel 40 where the display is not changed, the voltage Vp supplied to the pixel electrode 35 is set to a potential where a voltage change at the pixel electrode 35 corresponding to a voltage change at the capacity line 69 is predicted, and thus a voltage amplitude at the capacity line 69 can be increased. Thereby, it is possible to further suppress the useless power consumption in the storage capacitor C1.

FIG. 8 is a timing chart when the pixel 40 displays white.

A displayed image is erased before new display contents are written in the display region 5; however, there is a case where reset is performed so that the entire surface displays white by driving only the pixels 40 forming displayed image components to perform the image erasure. Here, when the pixel 40 which has displayed black is intended to display white again, as shown in FIG. 8, the selection transistor TRs is turned on via the selected scanning line 66 and, at the same time, in synchronization therewith, a third hold voltage Vh3 (first potential) is supplied to the capacity line 69. Thereby, the storage capacitor C1 is charged and simultaneously the voltage Vp at the pixel electrode 35 becomes the negative voltage −Ve. Thereafter, if the scanning line 66 is not selected, the selection transistor TRs is turned off, but the voltage Vp at the pixel electrode 35 is maintained by the storage capacitor C1, and the pixel 40 displays white.

Also, before the voltage Vp at the pixel electrode 35 is increased to the negative threshold voltage −Vth or more, a fourth hold voltage Vh4 (for example, a lower voltage by 7.5 V, second potential) lower than the third hold voltage Vh3 is applied to the storage capacitor C1 to decrease the voltage Vp at the pixel electrode 35, thereby preventing the voltage Vp at the pixel electrode 35 from being increased to the negative threshold voltage −Vth or more. Therefore, the pixel 40 displaying white is prevented from changing to a black display with the passing of time. Also, since a difference between the third hold voltage Vh3 and the fourth hold voltage Vh4 is needed, values of the voltages do not matter. Accordingly, for example, the third hold voltage Vh3 may employ the above-described second hold voltage Vh2, and the fourth hold voltage Vh4 may employ the first hold voltage Vh1.

In this way, even when the pixel 40 displays white, it is possible to further lengthen the driving time of the electrophoretic element 32 as compared with the driving time in the related art in the same manner as when the pixel 40 displays black. As a result, like the black display, it is possible to reduce the number of recharging times, to notably decrease the power consumption in the driving (parasitic capacitors in the source electrode or the like), and to increase the responsiveness of the electrophoretic element 32. Thereby, it is possible to reduce non-uniform display and thus to implement uniform display.

### Second Embodiment

Next, a second embodiment of the electrophoretic display device related to the invention will be described.

An electrophoretic display device 200 in this embodiment is different from the electrophoretic display device 100 in the previous embodiment in a configuration of a pixel circuit.

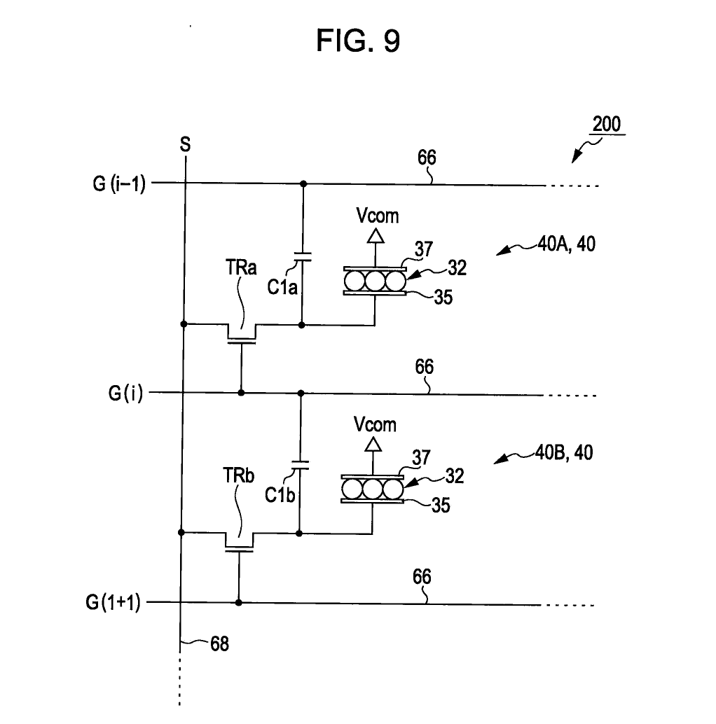

FIG. 9 is a configuration diagram illustrating a pixel circuit of the electrophoretic display device 200 in this embodiment.

As shown in FIG. 9, the respective pixels 40A in this embodiment and 40B include selection transistors TRa and TRb, storage capacitors C1a and C1b, pixel electrodes 35, electrophoretic elements 32, and the common electrodes 37. The constituent elements of each of the pixels 40A and 40B are the same as those of the pixel 40 in the previous embodiment, but are different in that one pair of electrodes of the storage capacitors C1a and C1b are connected to the scanning lines 66 (second scanning lines) connected to another pixel 40A (40B).

The selection transistor TRa of the pixel 40A has a gate connected to an i-th scanning line 66, a source connected to a data line 68, and a drain connected to one electrode of the storage capacitor C1a and the pixel electrode 35. The other electrode of the storage capacitor C1a is not connected to the capacity line but connected to a previous (i−1)-th scanning line 66.

The selection transistor TRb of the pixel 40B adjacent to the pixel 40A in the column direction has a gate connected to a (i+1)-th scanning line 66, a source connected to the data line 68, and a drain connected to one electrode of the storage capacitor C1b and the pixel electrode 35. The other electrode of the storage capacitor C1b is connected to the i-th scanning line 66.

The subscripts a and b are used to identify the elements in each row, and the subscripts will be omitted when there is no need for the identification in the following description.

Each of the scanning lines 66 is connected to the storage capacitor C1 of neighboring other pixels 40 in the column direction, and this non-selected scanning line 66 functions as a capacity line of the next pixel circuit. In this way, one electrode of the storage capacitor C1a (C1b) in a certain pixel 40 is connected to the scanning line 66 different from the scanning line 66 to which the selection transistor TRa (TRb) in the same pixel 40 is connected, and thereby it is possible to control the voltages Vh at the storage capacitors C1a and C1b connected to the respective scanning lines 66.

In this way, in this embodiment, since there is no need to form the capacity lines independently, the circuit configuration on the element substrate 30 is simplified, and thus there is an advantage in terms of manufacturing processes.

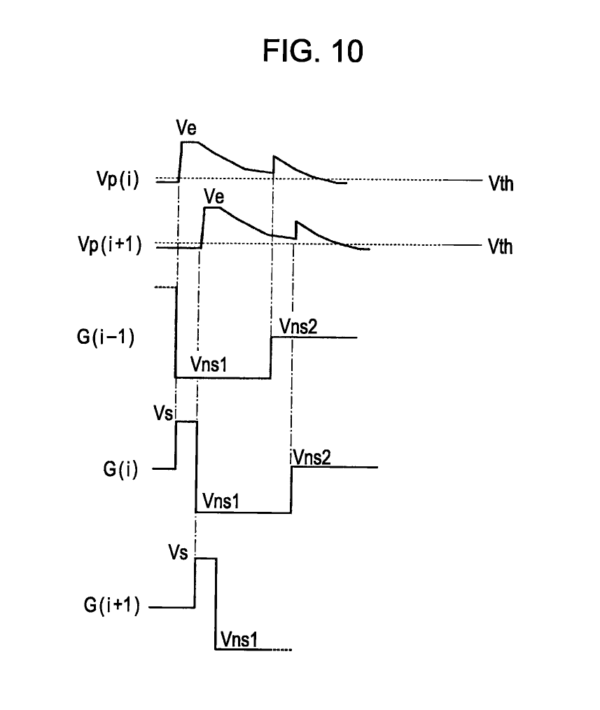

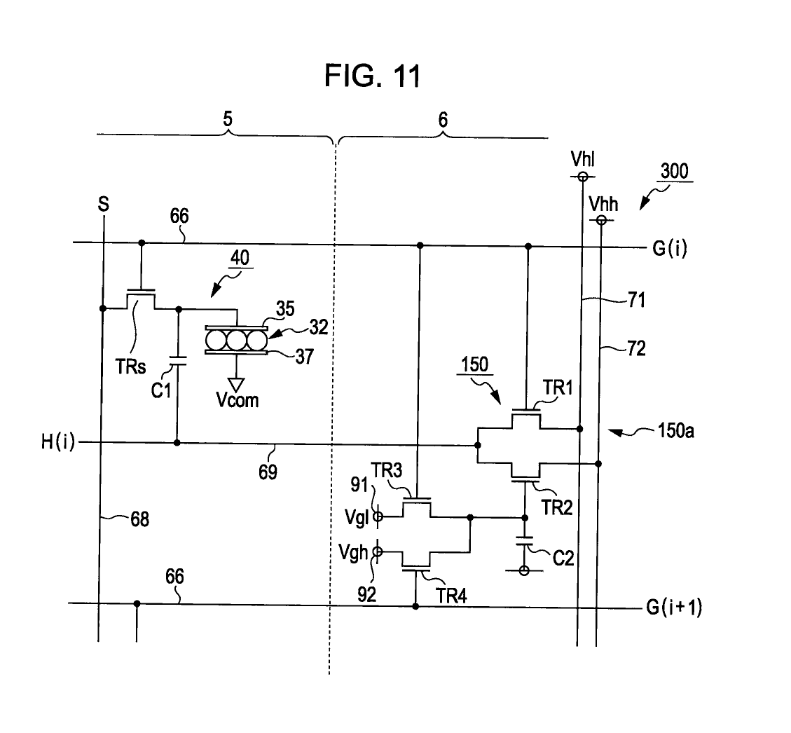

Next, a driving method of the electrophoretic display device 200 in this embodiment will be described with reference to FIG. 10.

FIG. 10 is a timing chart illustrating a driving method of the electrophoretic display device 200. In FIG. 10, during an image forming display period ST11 when black display images are displayed on the display region 5 which entirely displays white in the electrophoresis display device 200, a voltage waveform G(i−1) for the (i−1)-th scanning line 66, a voltage waveform G(i) for the i-th scanning line 66, a voltage waveform G(i+1) for the (i+1)-th scanning line 66, and voltage changes at the pixel electrode 35 (voltages Vp) of the pixels in the respective scanning lines 66 are shown.

The voltage waveforms for the respective scanning lines 66 are constituted by a selection voltage Vs (for example, +20 V), a first non-selection voltage Vns1 (for example, −27.5 V), and a second non-selection voltage Vns2 (for example, −20 V). First, the selection voltage Vs is applied only during a predetermined selection period, then the voltage Vns1 is applied only during a predetermined first non-selection period, and further the voltage Vns2 is applied only during a predetermined second non-selection period, and this operation is repeated for each row. The timings for applying the selection voltages are shifted by the selection periods for the respective rows or by the intervals or more.

Here, the operation will be described mainly based on the i-th pixel.

If the i-th scanning line 66 is selected and the selection voltage Vs is applied thereto, the selection transistor TRa is turned on, and thus the storage capacitor C1a is charged until a voltage at the pixel electrode 35 side of the storage capacitor C1a becomes the voltage Ve at the data line 68; however, at this time, a voltage at the other end of the storage capacitor C1a, that is, a voltage at the (i−1)-th scanning line 66 is the first non-selection voltage Vns1.

If the predetermined selection period ends, the first non-selection voltage Vns1 is applied to the i-th scanning line 66 to turn off the selection transistor TRa.

Thereby, the pixel electrode 35 enters the high impedance state, but the voltage Ve at the pixel electrode 35 is maintained by the energy stored in the storage capacitor C1. Accordingly, the electrophoretic element 32 is driven based on the potential difference between the pixel electrode 35 and the common electrode 37 and thus it is possible to implement a display corresponding to a desired grayscale.

Here, since the electrophoretic element 32 of the pixel 40A is driven by the storage capacitor C1, the potential at the pixel electrode 35 is gradually reduced due to the discharge in the storage capacitor C1.

At this time, before the voltage Vp at the pixel electrode 35 becomes the threshold voltage Vth or less, that is, at a point of time when the predetermined first non-selection period ends, the voltage at the (i−1)-th scanning line 66 is changed from the first non-selection voltage Vns1 to the second non-selection voltage Vns2.

Thereby, the voltage Vp at the pixel electrode 35 in each pixel 40A in the i-th row increases, and thus it is possible to suppress the voltage Vp from being reduced to the threshold voltage Vth or less. Therefore, useless power consumption in the storage capacitor C1a is reduced, and the electrophoretic element 32 is continuously driven.

In addition, in the case of i=1, this leads to (i−1)=0, and thus the scanning line 66 does not exist, but a scanning line 66 which does not participate in the display is formed, and then the driving may be performed in the same manner.

As described above, there is no need to form the capacity line independently by forming the storage capacitor C1 using the previous scanning line 66, and, for example, it is possible to easily manufacture a high definition pixel structure.

When the display state is changed to white, the first non-selection voltage Vns1 may be set to a voltage higher than the second non-selection voltage Vns2.

### Third Embodiment

A third embodiment of the electrophoretic display device related to the invention will be described.

An electrophoretic display device 300 in this embodiment has a configuration where a capacity line control circuit 150 is added to the electrophoretic display device 100 in the first embodiment.

FIG. 11 is a schematic configuration diagram of a display region 5 and a non-display region 6 of the electrophoretic display device 300 in this embodiment.

As shown in FIG. 11, the capacity line control circuit 150 is disposed in the non-display region 6 positioned outside the display region 5 where the pixel 40 of the electrophoretic display device 300 is arranged, and includes a switch circuit 150a which is provided to correspond to each capacity line 69 extending along the scanning line 66. The switch circuit 150a is provided to correspond to each capacity line 69 extending along the scanning line 66. The switch circuit 150a corresponding to an i-th (1≦i≦m) capacity line 69 switches and applies either a voltage supplied to a first supply line 71 (a first control line: Vhl) with a low voltage or a voltage supplied to a second supply line 72 (a second control line: Vhh) with a high voltage to the i-th capacity line 69, and is controlled by a voltage applied to the scanning line 66.

For example, the capacity line control circuit 150 has a first transistor TR1 (a first switch circuit), a second transistor TR2 (a second switch circuit), a third transistor TR3, a fourth transistor TR4, and a storage capacitor C2.

A gate of the first transistor TR1 is connected to the i-th scanning line 66, a source thereof is connected to the first supply line 71 (low voltage Vhl), and a drain thereof is connected to the i-th capacity line 69.

A gate of the second transistor TR2 is connected to a drain of the third transistor TR3, a drain of the fourth transistor TR4, and one electrode of the storage capacitor C2. A source of the second transistor TR2 is connected to the second supply line 72 (high voltage Vhh) and a drain thereof is connected to the i-th capacity line 69.

A gate of the third transistor TR3 is connected to the i-th scanning line 66, and a source thereof is connected to a low voltage line 91 (a third control line: Vgl).

A gate of the fourth transistor TR4 is connected to the (i+1)-th scanning line 66 (the second scanning line), and a source thereof is connected to a high voltage line 92 (a fourth control line: Vgh).

One electrode of the storage capacitor C2 is connected to the gate of the second transistor TR2, and the other electrode thereof is connected to a power supply having an arbitrary potential.

The electrophoretic display device in this embodiment has the above-described configuration.

An operation of the electrophoretic display device in this embodiment will be described mainly based on the i-th row.

First, if the i-th scanning line 66 is selected, a selection voltage is applied to the gate of the first transistor TR1 so as to be turned on. When the selection of the i-th scanning line 66 is finished, a non-selection voltage is applied to the gate thereof so as to be turned off.

As for the second transistor TR2, if the i-th scanning line 66 is selected, the selection voltage is applied to the gate of the third transistor TR3 so as to be turned on, and in turn the low voltage Vgl is supplied to the gate of the second transistor TR2, thereby turning off the second transistor TR2. If the (i+1)-th scanning line 66 is selected, the selection voltage is applied to the gate of the fourth transistor TR4 so as to be turned on, and in turn the high voltage Vgh is supplied to the gate of the second transistor TR2, thereby turning on the second transistor TR2. If the selection of the (i+1)-th scanning line 66 is finished, the fourth transistor TR4 is turned off. However, since the storage capacitor C2 is formed at the gate of the second transistor TR2, the voltage at the gate of the second transistor TR2 is maintained to be the high voltage Vgh and thus the second transistor TR2 is kept turned on.

As described above, when the i-th scanning line 66 is selected, the first transistor TR1 is turned on and the second transistor TR2 is turned off, and when the (i+1)-th scanning line 66 is selected, the first transistor TR1 is turned off and the second transistor TR2 is turned on. Therefore, to the i-th capacity line 69, the voltage Vhl at the first supply line 71 is supplied when the i-th scanning line 66 is selected, and the voltage Vhh at the second supply line 72 is supplied when the (i+1)-th scanning line 66 is selected.

The capacity line 69 is driven in the same manner as described in the first embodiment, and thus it is possible to achieve the same effects.

In FIG. 11 illustrating this embodiment, although the switch circuit 150a is formed at the right part of the display region 5 in the figure, the switch circuit 150a may be connected to an opposite end of the capacity line 69. In other words, the switch circuit 150a may be disposed along one side of the display region 5, and may be disposed along both sides opposite to each other of the display region 5. When disposed along both sides opposite to each other of the display region 5, the switch circuit 150a may be disposed to be connected to different ends (left and right of the display region 5) of the capacity lines 69 every row.

The storage capacitor C2 may be replaced with a parasitic capacitor such as the gate of the second transistor TR2. Also, the gates of the first and third transistors TR1 and TR3 may not be connected to the corresponding row (the i-th row) but connected to a previously selected row (i−j) (where j is a positive integer).

As described above in detail, the electrophoretic display device 300 in the third embodiment has the capacity line control circuit 150 and thus can control each capacity line 69 in synchronization with the selection operation of the scanning line 66. In addition, there is no need to form a driving circuit for controlling the capacity line 69 in the outside, and it is possible to simplify a configuration of wirings of driving circuits.

Due to the storage capacitor C2 of which one electrode is connected to the gate of the second transistor TR2 of the switch circuit 150a, the duration of the turned-on or turned-off period of the second transistor TR2 can be lengthened, and the high potential or the low potential can be reliably supplied during a period when the potential changing at the capacity line 69 is required.

### Fourth Embodiment

Next, a fourth embodiment of the electrophoretic display device related to the invention will be described.

An electrophoretic display device 400 in this embodiment is a modified example of the electrophoretic display device 300 in the third embodiment and is different in a configuration of the pixel circuit.

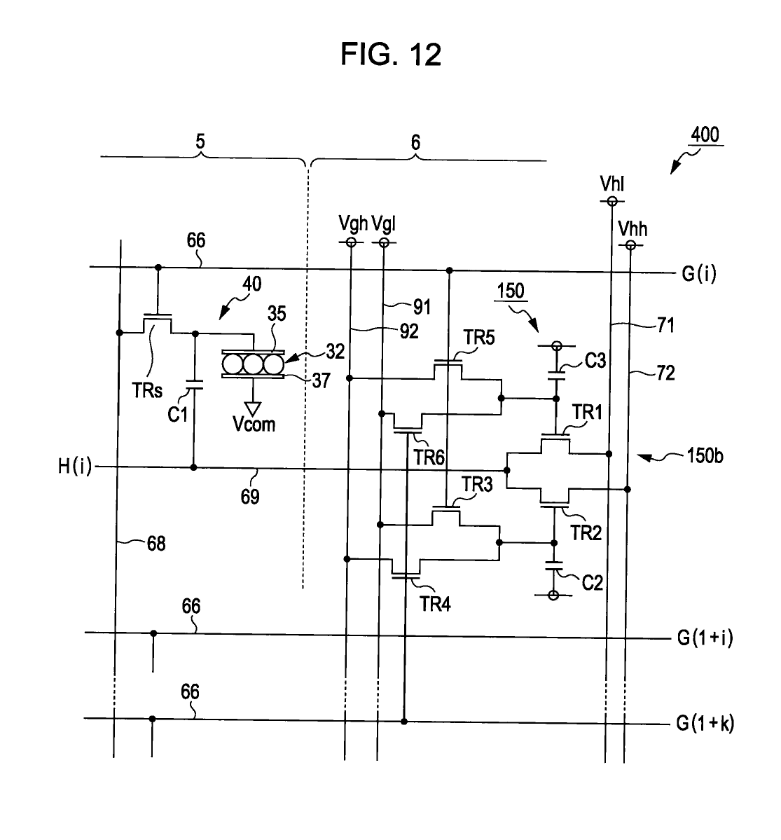

FIG. 12 is a schematic configuration diagram of the display region 5 and the non-display region 6 of the electrophoretic display device 400 in this embodiment.

As shown in FIG. 12, the capacity line control circuit 150 is disposed in the non-display region 6 positioned outside the display region 5 where the pixel 40 of the electrophoretic display device 400 is arranged, and includes a switch circuit 150b which is provided to correspond to each capacity line 69 extending along the scanning line 66. The switch circuit 150b is provided to correspond to each capacity line 69 extending along the scanning line 66. The switch circuit 150b corresponding to an i-th (1≦i≦m) capacity line 69 switches and applies either a voltage supplied to the first supply line 71 (the first control line: Vhl) with a low voltage or a voltage supplied to the second supply line 72 (the second control line: Vhh) with a high voltage, to the i-th capacity line 69, and is controlled by a voltage applied to the scanning line 66.

In other words, the switch circuit 150b has a first transistor TR1 (a first switch circuit), a second transistor TR2 (a second switch circuit), a third transistor TR3, a fourth transistor TR4, and a storage capacitor C2, and additionally a fifth transistor TR5, a sixth transistor TR6, and a storage capacitor C3.

Drains of the first transistor TR1 and the second transistor TR2 are connected to the i-th capacity line 69. Sources of the first transistor TR1 and the second transistor TR2 are respectively connected to the first supply line 71 (the low voltage Vhl) and the second supply line 72 (the high voltage Vhh). A gate of the first transistor TR1 is connected to drains of the fifth transistor TR5 and the sixth transistor TR6 and one end of the storage capacitor C3. A gate of the second transistor TR2 is connected to drains of the third transistor TR3 and the fourth transistor TR4 and the one end of the storage capacitor C3. The other ends of the storage capacitor C2 and the storage capacitor C3 are connected to a power supply having an arbitrary potential.

Gates of the third transistor TR3 and the fifth transistor TR5 are connected to the i-th scanning line 66, and the gates of the fourth transistor TR4 and the sixth transistor TR6 are connected to a (i+k)-th scanning line 66. Here, k is an integer equal to or more than 1, and if i+k>m, the gates thereof are connected to a (i+k−m)-th scanning line 66. Sources of the third transistor TR3 and the sixth transistor TR6 are connected to the low voltage line 91 (Vgl). Sources of the fourth transistor TR4 and the fifth transistor TR5 are connected to the high voltage line 92 (Vgh).

The electrophoretic display device in this embodiment has the above-described configuration.

An operation of the electrophoretic display device 400 in this embodiment will be described mainly based on the i-th row.

First, if the i-th scanning line 66 is selected, a selection voltage is applied to the gates of the third transistor TR3 and the fifth transistor TR5 so as to be turned on. On the other hand, since a non-selection voltage is applied to the gates of the fourth transistor TR4 and the sixth transistor TR6, they are turned off. Thereby, the high voltage Vgh is applied to the first transistor TR1 to be turned on, the low voltage Vgl is applied to the second transistor TR2 to be turned off, and the low voltage Vhl at the first supply line 71 is supplied to the i-th capacity line 69.

Next, if the selection of the i-th scanning line 66 is finished, the non-selection voltage is applied to the gates of the third transistor TR3 and the fifth transistor TR5 so as to be turned off. Thereby, the third transistor TR3 to the sixth transistor TR6 are all turned off. However, since the gates of the first transistor TR1 and the second transistor TR2 are respectively connected to the storage capacitor C3 and storage capacitor C2, the voltages at the gates of the first transistor TR1 and the second transistor TR2 are maintained to be a voltage the same as when the i-th scanning line 66 is selected. Thus, the first transistor TR1 lies in the turned-on state, the second transistor TR2 lies in turned-off state, and the voltage Vhl at the first supply line 71 continues to be supplied to the i-th capacity line 69.

If the (i+k)-th scanning line 66 is selected, the non-selection voltage is applied to the gates of the third transistor TR3 and the fifth transistor TR5 so as to be turned off. On the other hand, since the selection voltage is applied to the gates of the fourth transistor TR4 and sixth transistor TR6, they are turned on. Thereby, the low voltage Vgl is applied to the first transistor TR1 to be turned off, the high voltage Vgh is applied to the second transistor TR2 to be turned off, and the voltage Vhh at the second supply line is supplied to the i-th capacity line 69.

Also, if the selection of the (i+k)-th scanning line 66 is finished, the non-selection voltage is also applied to the gates of the fourth transistor TR4 and the sixth transistor TR6 so as to be turned off. Thereby, the third transistor TR3 to the sixth transistor TR6 are all turned off. However, since the gates of the first transistor TR1 and the second transistor TR2 are respectively connected to the storage capacitor C3 and storage capacitor C2, the voltages at the gates of the first transistor TR1 and the second transistor TR2 are maintained to be a voltage the same as when the (i+k)-th scanning line 66 is selected. Thus, the first transistor TR1 lies in the turned-off state, the second transistor TR2 lies in turned-on state, and the voltage Vhh at the second supply line 72 continues to be supplied to the i-th capacity line 69.

Therefore, to the i-th capacity line 69, the low voltage Vhl at the first supply line 71 is supplied when i-th scanning line 66 is selected, and this state is maintained until the (i+k)-th scanning line 66 is selected, and thereafter, the high voltage Vhh at the second supply line 72 is supplied.

Accordingly, the capacity line 69 is driven in the same manner as described in the first embodiment, and thus it is possible to achieve the same effects. In this modified example, the timing when the voltage applied to the capacity line 69 is changed from the voltage Vh1 to the voltage Vh2 can be set arbitrarily and thus the voltage at the pixel electrode 35 can be changed at a more optimal timing.

Here, the storage capacitors C2 and C3 may be replaced with parasitic capacitors such as the gates of the second transistor TR2 and the first transistor TR1.

Also, the respective gates of the third transistor TR3 and the fifth transistor TR5 may not be connected to the corresponding row (i-th row) but may be connected to a previously selected row (i—j) (where j is a positive integer).

While this invention has been described in connection with what is presently considered to be practical example embodiments, it is to be understood that the invention is not limited to the disclosed embodiments. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

For example, the operation of changing the potential at the storage capacitor C1 (capacity line 69) may be performed not limited to one time but several times. Thereby, the power consumption in the storage capacitor C1 can be further reduced and thus it is possible to further lengthen the driving time of the electrophoretic element 32. In addition, although the storage capacitor C1 is provided singly in each pixel 40, it may be provided in plurality, and the driving state of the electrophoretic element 32 may be maintained for a long time. As such an example, in addition to forming the capacity line 69 and the storage capacitor, the scanning line 66 and the storage capacitor are formed, and the first embodiment and the second embodiment may be used together.

When a predetermined pixel is changed to enter a desired display state, at least one potential of the first hold voltage Vh1 and the second hold voltage Vh2 may be changed depending on the changed display state. Thereby, for example, a changed polarity when a pixel displays white is made reverse to a changed polarity at the time of changing a polarity of the capacity line 69 after writing when the pixel displays black, and thus it is possible to considerably decrease the power consumption in the storage capacitor.

### Electronic Devices

Next, a case where the electrophoretic display devices 100 to 300 are applied to electronic devices in the above-described embodiments will be described.

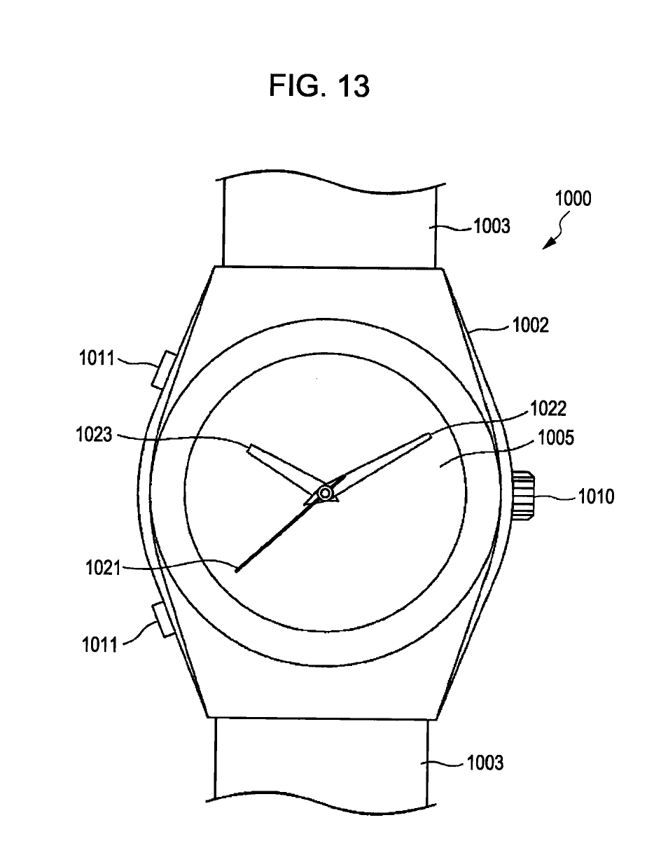

FIG. 13 is a front view of a wristwatch 1000. The wristwatch 1000 has a watch case 1002, and a pair of bands 1003 connected to the watch case 1002.

In the front face of the watch case 1002, there are provided a display region 1005, a second hand 1021, a minute hand 1022, and an hour hand 1023, which are implemented by the electrophoretic display device in each of the above-described embodiments. The watch case 1002 is provided with a winder 1010 and an operation button 1011 in its side surface, as operators. The winder 1010 is connected to a winding-stem (not shown) provided inside the case, and is integrally formed with the winding-stem so as to be pressed in multiple steps (for example, two steps) or rotated. The display region 1005 can display an image as a background, a character line such as date or time, or the second hand, the minute hand, the hour hand, or the like.

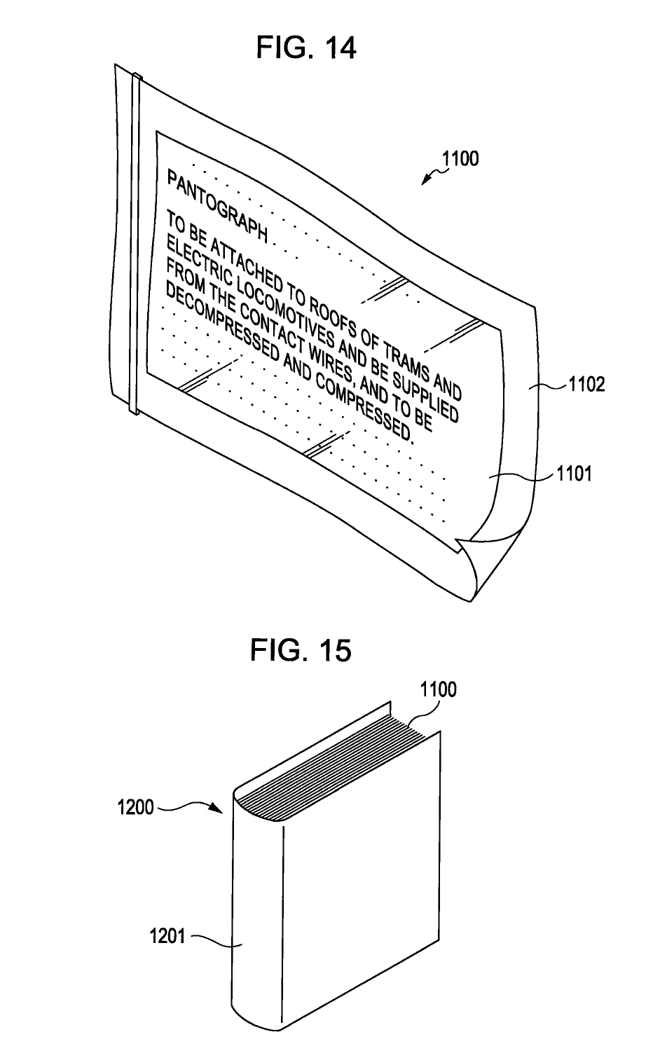

FIG. 14 is a perspective view illustrating a configuration of a sheet of electronic paper 1100. The electronic paper 1100 is provided with the electrophoretic display device in the above-described embodiments in its display region 1101. The electronic paper 1100 is flexible and has a main body 1102 which is constituted by a rewritable sheet having the same texture and bendability as paper in the related art.

FIG. 15 is a perspective view illustrating a configuration of an electronic note 1200. The electronic note 1200 has a configuration where the above-described electronic paper 1100 is bound in plurality together and then is inserted into a cover 1201. The cover 1201 includes, for example, a display data input means (not shown) for inputting display data sent from an external device. Thus, display contents can be changed or updated in the state where the electronic paper is bound, depending on the display data.

The above-described wristwatch 1000, the electronic paper 1100, and the electronic note 1200 employ the electrophoretic display device related to the invention, and thus electronic devices are implemented which have good operation reliability and include the display region with high display quality.

The above-described electronic devices illustrate electronic devices related to the invention, and do not limit the technical scope of the invention. For example, the electrophoretic display device related to the invention may be appropriately used for display regions of electronic devices such as, for example, mobile phones and portable audio devices.

The entire disclosure of Japanese Patent Application No. 2009-285025, filed Dec. 16, 2009 is expressly incorporated by reference herein.

What is claimed is:

1. An electrophoretic display device comprising:
an electrophoretic element having an electrophoretic layer interposed between a plurality of pixel electrodes and a common electrode;
a storage capacitor and a selection transistor provided corresponding to each of the pixel electrodes for each pixel;
a capacity line connected to an electrode of the storage capacitor; and
a control unit controlling potentials at the pixel electrodes, the common electrode, and the capacity lines,
wherein the control unit performs a potential writing operation of writing a predetermined potential in the storage capacitor and the pixel electrode during an image display period when images are displayed on a display region where the pixels are arranged; and
a potential changing operation of changing a potential at the capacity line from a first potential to a second potential after the selection transistor is turned off.

2. The electrophoretic display device according to claim 1, wherein the control unit performs the potential changing operation before a potential at the pixel electrode becomes lower than a threshold voltage of the electrophoretic element.

3. The electrophoretic display device according to claim 1, wherein the control unit changes a potential at the capacity line to the first potential before or at the same time as the potential writing operation.

4. The electrophoretic display device according to claim 1, further comprising a plurality of scanning lines and a plurality of data lines intersecting each other,
wherein a gate of the selection transistor is connected to a first scanning line, a drain of the selection transistor is connected to one electrode of the storage capacitor, and the other electrode of the storage capacitor is connected to a second scanning line different from the first scanning line.

5. The electrophoretic display device according to claim 1, wherein the control unit includes a capacity line control circuit provided corresponding to each of the plurality of capacity lines, and first and second control lines connected to the capacity line control circuit, and
wherein the capacity line control circuit includes a first switch circuit inserted between the capacity line and the first control line, and a second switch circuit inserted between the capacity line and the second control line, and
wherein the first switch circuit is turned on when a selection potential turning on the selection transistor is applied to a first scanning line to which a corresponding capacity line control circuit belongs or the previous scanning line selected prior to the first scanning line, and the second switch circuit is turned on when the selection potential is applied to a second scanning line different from the first scanning line.

6. The electrophoretic display device according to claim 5, wherein the first switch circuit of the capacity line control circuit is constituted by a first transistor, the second switch circuit thereof is constituted by a second transistor, and the capacity line control circuit includes a third transistor and a fourth transistor,
wherein drains of the first and second transistors are connected to the capacity line, a source of the first transistor is connected to the first control line, and a source of the second transistor is connected to the second control line,
wherein gates of the first and third transistors are connected to a first scanning line to which a corresponding capacity line control circuit belongs or the scanning line different from the first scanning line, and a gate of the second transistor is connected to drains of the third and fourth transistors,
wherein a source of the third transistor is connected to a third control line,
wherein a gate of the fourth transistor is connected to the second scanning line, and
wherein a source of the fourth transistor is connected to a fourth control line.

7. The electrophoretic display device according to claim 5, wherein the first switch circuit of the capacity line control circuit is constituted by a first transistor, the second switch circuit thereof is constituted by a second transistor, and the capacity line control circuit includes a third transistor, a fourth transistor, a fifth transistor, and a sixth transistor,
wherein drains of the first and second transistors are connected to the capacity line, a source of the first transistor is connected to the first control line, and a source of the second transistor is connected to the second control line,
wherein a gate of the first transistor is connected to drains of the fifth and sixth transistors, a gate of the second transistor is connected to drains of the third and fourth transistors, and gates of the third and fifth transistors are connected to the first scanning line or the scanning line different from the first scanning line,
wherein gates of the fourth and sixth transistors are connected to the second scanning line,
wherein sources of the third and sixth transistors are connected to a third control line, and
wherein sources of the fourth and fifth transistors are connected to a fourth control line.

8. The electrophoretic display device according to claim 1, wherein the storage capacitor is provided in plurality for each pixel.

9. A driving method of an electrophoretic display device including an electrophoretic element having an electrophoretic layer interposed between a plurality of pixel electrodes and a common electrode; a storage capacitor and a selection transistor provided corresponding to each of the pixel electrodes for each pixel; a capacity line connected to an electrode of the storage capacitor; and a control unit controlling potentials at the pixel electrodes, the common electrode, and the capacity lines, the driving method comprising:
performing a potential writing operation of writing a predetermined potential in the storage capacitor and the pixel electrode during an image display period when images are displayed on a display region where the pixels are arranged; and
performing a potential changing operation of changing a potential at the capacity line from a first potential to a second potential after the selection transistor is turned off.

10. The driving method according to claim 9, wherein the voltage changing operation is performed before a potential at the pixel electrode becomes lower than a threshold voltage of the electrophoretic element.

11. The driving method according to claim 9, wherein a potential at the capacity line is changed to the first potential before or at the same time as the potential writing operation.

12. The driving method according to claim 9, wherein a potential with a polarity opposite to a polarity of a voltage obtained by subtracting the first potential from the second potential is written in the pixel electrode of the corresponding pixel when a display using the pixel is intended to be maintained.

13. The driving method according to claim 9, wherein when a state of the pixel is intended to be changed to a desired display state, either the first potential or the second potential is changed depending on the changed state.

14. An electronic device comprising the electrophoretic display device according to claim 1.

15. An electronic device comprising the electrophoretic display device according to claim 2.

16. An electronic device comprising the electrophoretic display device according to claim 3.

17. An electronic device comprising the electrophoretic display device according to claim 4.

18. An electronic device comprising the electrophoretic display device according to claim 5.

19. An electronic device comprising the electrophoretic display device according to claim 6.

20. An electronic device comprising the electrophoretic display device according to claim 7.
